(19) United States
(12) Patent Application Publication
(10) Pub. No.: US 2019/0270651 A1
(43) Pub. Date: Sep. 5, 2019

(54) COMPOSITE FILTER CARTRIDGE HAVING SCALE INHIBITING CAPABILITY

(71) Applicant: XIAMEN FILTERTECH INDUSTRIAL CORPORATION, Xiamen (CN)

(72) Inventors: Feng-Shun Zhan, Xiamen (CN); Xian-Liang Guo, Xiamen (CN)

(21) Appl. No.: 16/288,109

(22) Filed: Feb. 28, 2019

(30) Foreign Application Priority Data
Mar. 2, 2018 (CN) 201810174353.1

(51) Int. Cl. C02F 1/00

(52) U.S. Cl. CPC C02F 1/001; C02F 1/441

(57) ABSTRACT

A composite filter cartridge having scale inhibiting capability, includes a front filter cartridge and a scale inhibiting filter cartridge. The scale inhibiting filter cartridge is disposed in the rear of the front filter cartridge. A water outlet end of the front filter cartridge is connected to a water inlet end of the scale inhibiting filter cartridge; and a water outlet end of the scale inhibiting filter cartridge is connected to a water outlet tube in the front filter cartridge.

### BACKGROUND OF THE INVENTION

### Field of the Invention

The present invention relates to a filter cartridge, and in particular to a composite filter cartridge having scale inhibiting capability used in a water purifier.

### The Prior Arts

In general, the RO (Reverse Osmosis) water purifying principle is also referred to as a Reverse Osmosis (RO) principle, that is currently utilized worldwide in water purifier, to perform filtering of raw water (physics method), then the water treated can be drinkable directly, without the need to add any compounds (so the water purifier is also referred to as a terminal water purifying device). For this reason, RO water purifier is now very popular in the market, and is widely accepted by the consumers. However, the present RO water purifier has a rather large volume, and it occupies quite a large space of a household especially for the city dwellers. The reason for this is that, for a water purifier utilized presently, the front filter cartridge and the scale inhibiting filter cartridge disposed in its rear are two separate pieces, and that require to use two separate installation spaces. Therefore, the water purifier is voluminous and occupies quite a large space, thus it can not be fitted into limited space in a household.

Therefore, presently, the design and performance of a water purifier is not quite satisfactory, and it leaves much room for improvements.

### SUMMARY OF THE INVENTION

In view of the problems and drawbacks of the prior art, the present invention provides a composite filter cartridge having scale inhibiting capability, that is novel in design, and easy in operation.

The present invention provides a composite filter cartridge having scale inhibiting capability, that includes: a front filter cartridge and a scale inhibiting filter cartridge. The scale inhibiting filter cartridge is disposed in the rear of the front filter cartridge. A water outlet end of the front filter cartridge is connected to a water inlet end of the scale inhibiting filter cartridge; and a water outlet end of the scale inhibiting filter cartridge is connected to a water outlet tube in the front filter cartridge.

In an aspect of the present invention, the front filter cartridge includes an outer shell, and the water outlet tube is disposed in a center of the outer shell. A carbon rod is sleeved around an outer perimeter of the water outlet tube, a water passage channel is disposed between the carbon rod and the water outlet tube, and the water passage channel is connected to the water inlet end of the scale inhibiting filter cartridge.

In another aspect of the present invention, the composite filter cartridge having scale inhibiting capability further includes: a PP fold film, sleeved around an outer perimeter of the carbon rod; and a water inlet channel, disposed on the outer shell, to work in cooperation with a water inlet end of the PP fold film.

In a yet another aspect of the present invention, the composite filter cartridge having scale inhibiting capability further includes a check valve, disposed on the water inlet channel.

In a further aspect of the present invention, the scale inhibiting filter cartridge includes a shell body, a water outlet connector is disposed on the shell body, to act in cooperation with the water outlet tube. A water input channel connected to the water passage channel is disposed on the shell body sleeved around a water inlet connector.

In an aspect of the present invention, the composite filter cartridge having scale inhibiting capability further includes: a scale inhibiting medium piece, disposed in the shell body to inhibit scale. A water outlet end of the scale inhibiting medium piece is connected to the water outlet connector.

In another aspect of the present invention, the composite filter cartridge having scale inhibiting capability further includes two PP cotton pieces, disposed respectively on a water inlet end and on the water outlet end of the scale inhibiting medium piece.

In a yet another aspect of the present invention, the composite filter cartridge having scale inhibiting capability further includes: a lug, disposed on an upper end of the shell body; and an insertion slot, disposed in a lower end of the outer shell, to act in cooperation with the lug.

Compared with the Prior Art, the composite filter cartridge having scale inhibiting capability of the present invention has the following advantages: firstly, it could drastically reduce its volume and the space it occupies. Secondly, since the service life of the RO film filter cartridge is longer, while the service life of the scale inhibiting filter cartridge is shorter, so that when the respective service lives is approaching, they can be replaced separately and conveniently, to achieve maximum utilization of the respective filter cartridges.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is an exploded view of a composite filter cartridge having scale inhibiting capability according to the present invention; and

FIG. 2 is a cross section view of a composite filter cartridge having scale inhibiting capability according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the following, an embodiment is used to describe the various details of the present invention. However, it does not mean that this embodiment represents all the embodiments of the present invention. Other embodiments can be envisaged by people familiar with this field, and thus they all fall into the scope of the present invention.

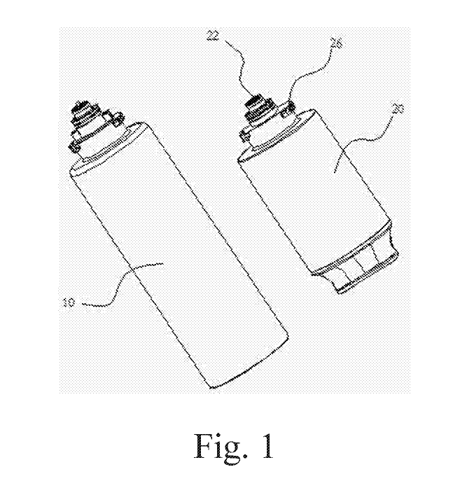

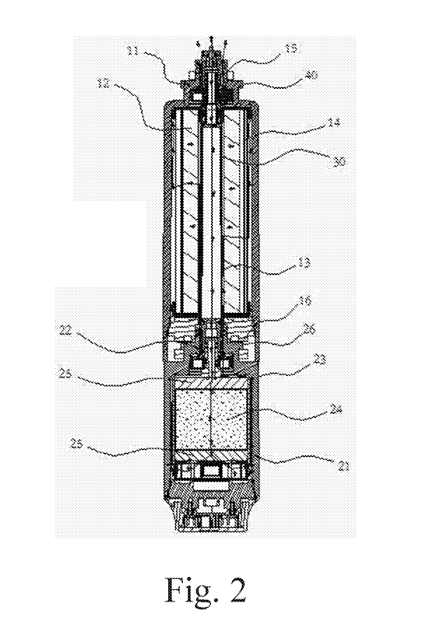

Refer to FIGS. 1-2 respectively for an exploded view of a composite filter cartridge having scale inhibiting capability according to the present invention; and a cross section view of a composite filter cartridge having scale inhibiting capability according to the present invention.

As shown in FIGS. 1-2, the present invention provides a composite filter cartridge having scale inhibiting capability, that includes: a front filter cartridge 10 and a scale inhibiting filter cartridge 20. The scale inhibiting filter cartridge 20 is disposed in the rear of the front filter cartridge 10. A water outlet end of the front filter cartridge 10 is connected to a water inlet end of the scale inhibiting filter cartridge 20; and a water outlet end of the scale inhibiting filter cartridge 20 is connected to a water outlet tube 30 in the front filter cartridge 10.

In an embodiment of the present invention, the front filter cartridge 10 includes an outer shell 11, and the water outlet tube 30 is disposed in a center of the outer shell 11. A carbon rod 12 is sleeved around an outer perimeter of the water outlet tube 30, a water passage channel 13 is disposed between the carbon rod 12 and the water outlet tube 30, and the water passage channel 13 is connected to the water inlet end of the scale inhibiting filter cartridge 20. Further, in order to achieve better filtering effect for the front filter cartridge 10, a PP fold film 14 is sleeved around an outer perimeter of the carbon rod 12; and a water inlet channel 15 is disposed on the outer shell 11, to work in cooperation with a water inlet end of the PP fold film 14. Moreover, a check valve 40 is disposed on the water inlet channel 15, such that the water filtered through the front filter cartridge 10 flows through PP fold film 14 and the carbon rod 12 in sequence for filtering. And then, the filtered water flows to the scale inhibiting filter cartridge 20 through the water passage channel 13.

Further, the scale inhibiting filter cartridge 20 includes a shell body 21, a water outlet connector 22 is disposed on the shell body 21, to act in cooperation with the water outlet tube 30. A water input channel 23 connected to the water passage channel 13 is disposed on the shell body 21 sleeved around a water inlet connector. A scale inhibiting medium piece 24 is disposed in the shell body 21 to inhibit scale. A water outlet end of the scale inhibiting medium piece 24 is connected to the water outlet connector 22. Two PP cotton pieces 25 are disposed respectively on the water inlet end and on the water outlet end of the scale inhibiting medium piece 24.

In an embodiment of the present invention, a lug 26 is disposed on an upper end of the shell body 21; and an insertion slot 16 is disposed in a lower end of the outer shell 11, to act in cooperation with the lug 26. More specifically, the insertion slot 16 includes a vertical slot and a lateral slot disposed on the outer shell 11. As such, in installation, the lug 26 is aligned with the vertical slot, to insert the scale inhibiting filter cartridge 20 into the lower end of the outer shell 11. Next, rotate the scale inhibiting filter cartridge 20, to make the lug 26 to receive in the lateral slot, so that the scale inhibiting filter cartridge 20 and the outer shell 11 are connected firmly together. In detaching, all that is required to do is to rotate the scale inhibiting filter cartridge 20, to align the lug 26 with the vertical slot. Then pull the scale inhibiting filter cartridge 20 out from the outer shell 11, to achieve detaching easily and conveniently.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A composite filter cartridge having scale inhibiting capability, comprising:
a front filter cartridge; and
a scale inhibiting filter cartridge, disposed in rear of the front filter cartridge, wherein a water outlet end of the front filter cartridge is connected to a water inlet end of the scale inhibiting filter cartridge, and a water outlet end of the scale inhibiting filter cartridge is connected to a water outlet tube in the front filter cartridge.

2. The composite filter cartridge having scale inhibiting capability as claimed in claim 1, wherein the front filter cartridge includes an outer shell, and the water outlet tube is disposed in a center of the outer shell, a carbon rod is sleeved around an outer perimeter of the water outlet tube, a water passage channel is disposed between the carbon rod and the water outlet tube, and the water passage channel is connected to the water inlet end of the scale inhibiting filter cartridge.

3. The composite filter cartridge having scale inhibiting capability as claimed in claim 2, further comprising:
a PP fold film, sleeved around an outer perimeter of the carbon rod; and
a water inlet channel, disposed on the outer shell, to work in cooperation with a water inlet end of the PP fold film.

4. The composite filter cartridge having scale inhibiting capability as claimed in claim 3, further comprising:
a check valve, disposed on the water inlet channel.

5. The composite filter cartridge having scale inhibiting capability as claimed in claim 1 wherein the scale inhibiting filter cartridge includes a shell body, a water outlet connector is disposed on the shell body, to act in cooperation with the water outlet tube, and a water input channel connected to the water passage channel is disposed on the shell body sleeved around a water inlet connector.

6. The composite filter cartridge having scale inhibiting capability as claimed in claim 5, further comprising:
a scale inhibiting medium piece, disposed in the shell body to inhibit scale, a water outlet end of the scale inhibiting medium piece is connected to the water outlet connector.

7. The composite filter cartridge having scale inhibiting capability as claimed in claim 6, further comprising:
two PP cotton pieces, disposed respectively on a water inlet end and on the water outlet end of the scale inhibiting medium piece.

8. The composite filter cartridge having scale inhibiting capability as claimed in claim 7, further comprising:
a lug, disposed on an upper end of the shell body; and
an insertion slot, disposed in a lower end of the outer shell, to act in cooperation with the lug.
